(19) United States
(12) Patent Application Publication
(10) Pub. No.: US 2024/0403717 A1
(43) Pub. Date: Dec. 5, 2024

(54) GENERATING SYNTHETIC DATA FOR MACHINE PERCEPTION

(71) Applicant: Cognata Ltd., Rehovot (IL)

(72) Inventor: Dan ATSMON, Rehovot (IL)

(73) Assignee: Cognata Ltd., Rehovot (IL)

(21) Appl. No.: 18/699,632

(22) PCT Filed: Oct. 25, 2022
(86) PCT No.: PCT/IL2022/051123

§ 371 Date: Apr. 9, 2024

Related U.S. Application Data
(60) Provisional application No. 63/271,320, filed on Oct. 25, 2021.

(51) Int. Cl. G06N 20/00

(52) U.S. Cl. CPC G06N 20/00

(57) ABSTRACT

A method for training a computer-vision based perception model, comprising: increasing diversity of backgrounds behind objects in synthetic training data by: inserting into a scene in simulation data at least one simulation object distributed around a sensor position in the scene, such that the at least one simulation object is oriented towards the sensor position, to produce new simulation data; and computing at least one simulated sensor signal using the new simulation data, simulating at least one signal captured by a simulated sensor located in the sensor position; and providing the new simulation data and the at least one simulated sensor signal as synthetic training data to at least one computer-vision based perception model for training the model to detect and additionally or alternatively classify one or more objects in one or more sensor signals.

### RELATED APPLICATION/S

This application claims the benefit of priority of U.S. Provisional Patent Application No. 63/271,320 filed on Oct. 25, 2021, the contents of which are incorporated herein by reference in their entirety.

### BACKGROUND

Some embodiments described in the present disclosure relate to machine perception and, more specifically, but not exclusively, to computer-vision based perception.

The term perception, as used herewithin, refers to interpretation of sensory information, such as sight, hearing (audio), smell and touch. More specifically, as used herewithin, the term perception refers to detection and recognition of objects in a scene using sensory information. For example, when a person observes a room by looking around the room, a person may detect a piece of furniture in the room and recognize it as a chair. In another example, a person hears an audio recording of many sounds, detects some sounds being emitted by one entity and recognizing those sounds as a siren of an ambulance. Alternatively, the person may recognize the sounds as an identified popular song. The term perception refers to perception in a physical scene as well as perception in signals representing a scene.

The term “machine perception”, as used herewithin, refers to the capability of a computerized system to interpret data to derive meaningful information in a manner that is similar to the way humans use their senses to derive meaningful information from the world around them. Thus, machine perception refers to detecting and additionally or alternatively recognizing objects in digital data representing a scene. In the field of machine perception, recognition of an object is done by way of classification. Thus, as used herewithin, machine perception refers to detection of objects in digital data and additionally or alternatively classification of the detected objects. The digital data may comprise one or more digital signals captured by a sensor in a physical scene. For example, a signal may be a digital image captured by a camera, or a digital video captured by a video camera, from a physical scene. Machine perception is not limited to visual signals. For example, a signal may be an audio signal captured by a microphone placed in a street. In another example, a signal may be captured by a thermal sensor, for example a thermal sensor of a security system. The digital data may comprise one or more digital signals simulating signals captured in a physical scene.

There is an increase in an amount of systems and in an amount of types of systems that use machine perception, for example in the field of driving. The term “autonomous driving system” (ADS) refers to a vehicle that is capable of sensing its environment and of moving safely in the environment, possibly with some human input. The term “advanced driver-assistance system” (ADAS) refers to a system that aids a vehicle driver while driving by sensing its environment. A vehicle comprising an ADAS may comprise one or more sensors, each capturing one or more signals providing input to the ADAS. Some systems that use machine perception are autonomous systems. Some systems that use machine perception are not autonomous.

Another example of a system that uses machine perception is an augmented reality (AR) system. Such systems may use machine perception to analyze a scene in order to augment it.

While there are a variety of methods for performing machine perception, use of machine learning models is increasing rapidly. Machine learning refers to the ability of a computer program to improve automatically through experience. A machine learning model is the product of a machine learning training process, typically a computer-executable program or object (or set of objects).

For brevity, unless otherwise indicated the term “model” is used henceforth to mean a machine learning model.

In addition, the following description focuses on training a machine learning model however the system and methods described may apply additionally or alternatively to testing, validation or verification (or any combination thereof) of a model or a system using a model for perception. In addition, the machine learning model may be used, among other purposes, for one or more of: object detection, object classification, depth estimation and segmentation, i.e. partitioning a digital image into a plurality of segments, also known as image regions.

### SUMMARY

Some embodiments described in the present disclosure describe a system and a method for increasing diversity of backgrounds behind objects in synthetic training data by inserting into a scene in simulation data one or more simulation objects distributed around a sensor position in the scene, such that the one or more simulation objects are oriented towards the sensor position, to produce new simulation data; and computing at least one simulated sensor signal using the new simulation data, simulating at least one signal captured by a simulated sensor located in the sensor position. Optionally, the simulated sensor pivots around an axis in the sensor position. Inserting one or more simulation objects oriented towards the sensor position increases a likelihood of capturing by the simulated sensor a front view of each of the one or more simulation objects. Pivoting the simulated sensor around an axis in the sensor position allows capturing each of the one or more simulation objects in a plurality of orientations and angles relative to the simulated sensor and with a plurality of backgrounds all in a single frame, thus increasing diversity of the synthetic training data without increasing size of the synthetic training data.

The foregoing and other objects are achieved by the features of the independent claims. Further implementation forms are apparent from the dependent claims, the description and the figures.

According to a first aspect, a system for training a computer-vision based perception model comprises at least one hardware processor adapted for: generating synthetic training data by: generating new simulation data describing a new simulated scene by inserting into simulation data describing a simulated scene at least one object, selected from a set of simulation objects, the at least one object inserted in an object position in the simulated scene generated relative to a sensor position in the simulated scene according to a target coverage function, each object of the at least one object having a front view, the object inserted into the simulated scene such that the object's front view is oriented towards the sensor position; and computing at least one simulated sensor signal, simulating at least one signal captured by a simulated sensor located in the sensor position in the new simulated scene; and providing the new simulation data and the at least one simulated sensor signal as synthetic training data to at least one computer-vision based perception model for training the model to detect and additionally or alternatively classify one or more objects in one or more sensor signals.

According to a second aspect, a method for training a computer-vision based perception model comprises: generating synthetic training data by: generating new simulation data describing a new simulated scene by inserting into simulation data describing a simulated scene at least one object, selected from a set of simulation objects, the at least one object inserted in an object position in the simulated scene generated relative to a sensor position in the simulated scene according to a target coverage function, each object of the at least one object having a front view, the object inserted into the simulated scene such that the object's front view is oriented towards the sensor position; and computing at least one simulated sensor signal, simulating at least one signal captured by a simulated sensor located in the sensor position in the new simulated scene; and providing the new simulation data and the at least one simulated sensor signal as synthetic training data to at least one computer-vision based perception model for training the model to detect and additionally or alternatively classify one or more objects in one or more sensor signals.

According to a third aspect, a software program product for training a computer-vision based perception model comprises: a non-transitory computer readable storage medium; first program instructions for generating synthetic training data by: generating new simulation data describing a new simulated scene by inserting into simulation data describing a simulated scene at least one object, selected from a set of simulation objects, the at least one object inserted in an object position in the simulated scene generated relative to a sensor position in the simulated scene according to a target coverage function, each object of the at least one object having a front view, the object inserted into the simulated scene such that the object's front view is oriented towards the sensor position; and computing at least one simulated sensor signal, simulating at least one signal captured by a simulated sensor located in the sensor position in the new simulated scene; and second program instructions for providing the new simulation data and the at least one simulated sensor signal as synthetic training data to at least one computer-vision based perception model for training the model to detect and additionally or alternatively classify one or more objects in one or more sensor signals; wherein the first and second program instructions are executed by at least one computerized processor from the non-transitory computer readable storage medium.

According to a fourth aspect, an autonomous driving system comprises: at least one sensor; at least one decision component; and at least one computer-vision based perception model connected to the at least one sensor and the at least one decision component, the at least one perception model trained to detect and additionally or alternatively classify one or more objects in one or more sensor signals, the training comprising: generating synthetic training data by: generating new simulation data describing a new simulated scene by inserting into simulation data describing a simulated scene at least one object, selected from a set of simulation objects, the at least one object inserted in an object position in the simulated scene generated relative to a sensor position in the simulated scene according to a target coverage function, each object of the at least one object having a front view, the object inserted into the simulated scene such that the object's front view is oriented towards the sensor position; and computing at least one simulated sensor signal, simulating at least one signal captured by a simulated sensor located in the sensor position in the new simulated scene; and providing the new simulation data and the at least one simulated sensor signal as synthetic training data to the at least one computer-vision based perception model for training the model to detect and additionally or alternatively classify the one or more other objects in the one or more other sensor signals; wherein the at least one perception model is configured for: receiving by the at least one computer-vision based perception model one or more other sensor signals from the at least one sensor; detecting one or more other objects in the one or more other sensor signals; and providing an indication of the one or more other objects to the at least one decision component.

According to a fifth aspect, a method for training a computer-vision based perception model comprises: generating synthetic training data by: inserting into a scene in simulation data at least one object distributed around a sensor position in the scene, such that the at least one object is oriented towards the sensor position, to produce new simulation data; and computing at least one simulated sensor signal using the new simulation data, simulating at least one signal captured by a simulated sensor located in the sensor position; and providing the new simulation data and the at least one simulated sensor signal as synthetic training data to at least one computer-vision based perception model for training the model to detect and additionally or alternatively classify one or more objects in one or more sensor signals.

With reference to the first and second aspects, in a first possible implementation of the first and second aspects each object of the set of simulation objects has one or more rotation angle ranges, each rotation angle range being in relation to a plane relative to a reference plane in the simulated scene; and the at least one object is inserted in the object position such that for at least one rotation angle range of the one or more rotation angle ranges, the at least one object's front view is rotated relative to the sensor position on the respective plane of the rotation angle range at an angle selected from the at least one rotation angle range. Optionally, the angle is selected at random from the at least one rotation angle range. Rotating the at least one object's front view relative to the sensor position increases a variety of orientations of the one or more objects towards the sensor, increasing accuracy of a model trained using synthetic data comprising the variety of object orientations. Selecting the angle at random further increases the variety of orientations of the one or more objects. Optionally, the sensor position in the simulated scene is selected at random. Optionally, the sensor position in the simulated scene is computed according to at least one position acceptance test. Selecting a sensor position in the simulated scene according to at least one position acceptance test increases a likelihood that the one or more simulated sensor signals are representative of a signal captured by a sensor, thus increasing accuracy of a perception model trained using the one or more simulated sensor signals.

With reference to the first and second aspects, in a second possible implementation of the first and second aspects the object position in the simulated scene is selected at random. Optionally, inserting the at least one object into the simulation data comprises: for each of one or more base distances: computing an angular density according to the target coverage function and the set of simulation objects; randomly selecting one or more positions in the simulated scene according to the angular density, each at the respective base distance from the sensor position and having an angular offset with respect to an identified orientation of the sensor; and for each of the one or more positions: selecting a simulation object from the set of simulation objects; and adding the simulation object to the simulation data at an object position in the simulated scene that is at the base distance from the sensor position and has the angular offset with respect to the identified orientation of the sensor. Distributing the one or more objects in one or more concentric circles around the sensor position facilitates capturing in the one or more simulated signals a variety of simulated objects with a variety of backgrounds and orientations towards the simulated sensor, increasing accuracy of a perception model trained using the one or more simulated sensor signals. Optionally, further for each of the one or more positions comprises: computing a random offset from the base distance, such that the random offset is in an identified range of distance offsets; computing an object distance by adding the random offset to the base distance; and adding the simulation object to the simulation data at another object position in the simulated scene that is at the object distance from the sensor position and has the angular offset with respect to the identified orientation of the sensor, instead of at the object positon that is at the base distance from the sensor position. Placing the one or more objects in an outline of a circle around the sensor position but not at exactly equal distances increases variety of backgrounds of the objects in the simulated scene, thus increasing accuracy of a perception model trained using the one or more simulated sensor signals. Optionally, the set of simulation objects comprises a subset of objects of interest. Optionally, the one or more base distances comprise at least one close distance and at least one background distance, where each of the at least one close distance is less than any of the at least one background distance. Optionally, for the at least one close distance, the respective one or more objects selected therefor are selected from the subset of objects of interest and for the at least one background distance the respective one or more objects selected therefor are not members of the subset of objects of interest. Placing objects of interest closer to the sensor position increases a likelihood of capturing in the one or more simulated sensor signals an object of interest with a variety of backgrounds, increasing accuracy of a perception model trained using the one or more simulated sensor signals.

With reference to the first and second aspects, in a third possible implementation of the first and second aspects the set of simulation objects comprises at least one of: a car, a truck, a motorized vehicle, a train, a boat, an air-born vehicle, a waterborne vessel, a motorized scooter, a scooter, a bicycle, a road sign, a household object, a bench, a post, a person, an animal, a vegetation, a sidewalk, a curb, a traffic sign, a billboard, an obstacle, a mountain wall, a ditch, a rail, a fence, a building, a wall, and a road mark. Optionally, adding the at least one object to the simulated scene is according to one or more physical constraints applied to the at least one object and the simulated scene. Applying one or more physical constrained to the at least one objects increases usability of the generated simulation data by preserving a realistic structure of the new simulated scene, increasing accuracy of a perception model trained using the synthetic training data generated using the new simulated scene.

With reference to the first and second aspects, in a fourth possible implementation of the first and second aspects the at least one object is selected at random from the set of simulation objects. Optionally, each of the set of simulation objects has a plurality of object classifications, and the at least one object has at least one target object classification, identified by applying the target coverage function to the simulation data. Optionally, the at least one target object classification comprises at least one of: an identified color, an identified size, and an identified shape. Selecting the one or more objects to have at least one target object classification facilitates generating synthetic training data that meets a target coverage function, increasing accuracy of a perception model trained using the synthetic training data. Optionally, applying the target coverage function to the simulation data comprises: identifying a plurality of simulation objects in the simulation data; computing a plurality of identified object classifications of the plurality of simulation objects; computing a plurality of statistical values according to the plurality of identified object classifications; and identifying the at least one target object classification according to the plurality of statistical values.

With reference to the first and second aspects, in a fifth possible implementation of the first and second aspects computing the at least one simulated sensor signal comprises the simulated sensor pivoting around an axis in the sensor position.

With reference to the fourth aspect, in a first possible implementation of the fourth aspect the at least one perception model is further configured for classifying the one or more other objects. Optionally, classifying the one or more other objects is alternatively to detecting the one or more other objects in the one or more other sensor signals.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments pertain. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a block diagram schematically showing an exemplary system for generating synthetic training data, according to some embodiments;

FIG. 2 is a flowchart schematically representing an optional flow of operations for generating synthetic training data, according to some embodiments;

FIG. 3 is a flowchart schematically representing an optional flow of operations for adding objects to a simulated scene, according to some embodiments;

FIG. 4 is a block diagram schematically showing an exemplary distribution of objects around a sensor position, according to some embodiments;

FIG. 5 is a flowchart schematically representing an optional flow of operations for computing a target object classification, according to some embodiments;

FIG. 6 is a block diagram schematically showing an exemplary perception system, according to some embodiments;

FIG. 7 is a flowchart schematically representing an optional flow of operations for a perception system, according to some embodiments; and

FIGS. 8A, 8B and 8C are exemplary digital images captured from an exemplary new simulation scene, according to some embodiments.

### DETAILED DESCRIPTION

The present description focuses on computer-vision based perception, however some methods may apply to other senses.

Some methods for training a machine learning model involve providing the model with input data that is annotated according to a target function of the model, such that the input data serve as examples for the machine learning model to learn from. A machine learning model trained to detect and additionally or alternatively classify objects in input data may be trained with input data annotated to indicate objects in the input data and their classification.

Accuracy of machine perception, that is accurate detection of an object in input data and additionally or alternatively accurate classification of the object, is effected by many factors. For example, correct classification of a traffic sign in a digital image may depend on how much of the text on the sign is visible to the sensor that captured the digital image, depending on a relative angle between the sensor and the sign. Contrast between the object and its background also effects perception. Lighting, shading, noise introduced by the sensor, poor capturing conditions (some examples being background noise in an audio signal and poor focus in an image) and other factors may impact an ability of a model to perceive an object in input data.

Accuracy of a machine learning model depends on the diversity of data used when training it. To produce a robust machine learning model for machine perception there is a need to provide the model with a large variety of the objects the model is expected to detect and classify, in terms of types, size, distance, orientation, lighting, backgrounds etc. The term target coverage function refers to a set of object attributes, each with a target range of values, that need to be represented in training data to increase accuracy of a modeled trained using this training data.

As it is expensive to capture such a variety of scenarios, some systems are trained using synthetic training data.

When the model is used to detect and additionally or alternatively classify objects in dynamic data, that is data that is captured (or data that simulates capturing) over time, for example an audio signal or a digital video, some methods for generating synthetic training data require simulating a scene in which the data is captured. In order to generate diverse training data there is a need to execute a large amount of simulations which is expensive in terms of time and amount of computer resources required. In addition, diverse training data generated using straightforward simulation of a realistic scene may comprise very large data sets in order to cover the target coverage function, which increases training time of the machine learning model.

There is a need to reduce cost of producing diverse training data for machine perception and reduce the size of the training data needed to train a model without reducing accuracy of the trained model. Diversity of the training data may be measured according to a target coverage function. The target coverage function includes for example one or more of: a type of objects, a view of an object (for example, a front view), a range of distances from a sensor, a range of relative angles between an object and a sensor, a range of lighting conditions, a range of background colors and textures, and a range of “degrees of clutter” of the scene.

As used herewithin, the terms “simulation object” and “simulated object” both refer to objects for simulation data and the terms are used interchangeably. The simulation objects may be in simulation data; the simulation objects may be added to simulation data.

Some methods for increasing diversity in synthetic data comprise inserting objects at random into the synthetic data, or inserting objects at random into a simulation and capturing data from the simulation (for example simulating a signal captured by a sensor operating in the simulation). However, such methods still require producing very large amounts of training data in order to achieve good coverage according to the target coverage function. One problem is that the sensor is such a simulation captures objects only according to its orientation in the simulation.

The present disclosure proposes, in some embodiments described herewithin, inserting into simulation data describing a simulated scene an unnatural amount of simulated objects scattered around an identified observation point of a sensor, while still preserving “law of nature” physical constraints (some examples being: traffic signs come out of the ground and a car is on the ground). Some examples of a sensor are: a camera, an electromagnetic radiation sensor, a thermal sensor, an ultrasound sensor, a radar, a Light Detection and Ranging (LIDAR) sensor, a microphone, a thermometer, an accelerometer, and a video camera.

Optionally an inserted simulation object is rotated according to a rotation range associated with the simulation object. In such embodiment the present disclosure further proposes placing each of one or more objects at one of a plurality of poses with relation to the sensor, such that the one or more objects are placed over a 360-degree arc around the sensor. Such placement creates a variety of backgrounds for the one or more objects. According to such embodiments, the one or more objects are inserted facing the identified observation point of the sensor. In such embodiments, the sensor is simulated to capture the simulated scene from the observation point. Optionally, the sensor is simulated to capture the simulated scene while the sensor swivels on its axis at the observation point such that one rotation of the sensor captures many objects in many angles relative to the sensor at many distances.

Optionally, the one or more objects are placed in the simulated scene randomly. Optionally, the one or more objects are distributed according to the target coverage function requirements, for example in terms of distances from the sensor, density of objects in an area, orientation relative to the sensor, etc. The rotation of the sensor around its axis creates multiple angles of the same object in the same captured signal in a single frame, increasing coverage according to the target coverage function without increasing the size of the training data. Scattering the one or more objects and placing them at various distances creates a variety of backgrounds for the one or more objects and allows capturing the one or more objects from a variety of distances, again increasing coverage according to the target coverage function.

In addition, in some embodiments described herewithin, the one or more objects are selected according to a target classification, for example triangular sign posts or vehicles having an identified color. Optionally, the target classification is computed according to the target coverage function, for example by analyzing the simulation data to identify one or more target classifications that are not sufficiently represented in the simulation data according to the target coverage function.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code, natively compiled or compiled just-in-time (JIT), written in any combination of one or more programming languages, including an object oriented programming language such as Smalltalk, C++, Java, Object-Oriented Fortran or the like, an interpreted programming language such as JavaScript, Python or the like, and conventional procedural programming languages, such as the “C” programming language, Fortran, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

According to some embodiments, synthetic training data is generated by at least one hardware processor and is provided to one or more perception models for the purpose of training the one or more perception models to detect one or more objects in one or more sensor signals. The one or more perception models may be trained to additionally or alternatively classify the one or more objects. Optionally, the one or more perception models are one or more computer-vision based perception model.

For brevity, henceforth the term “processing unit” is used to mean “at least one hardware processor”.

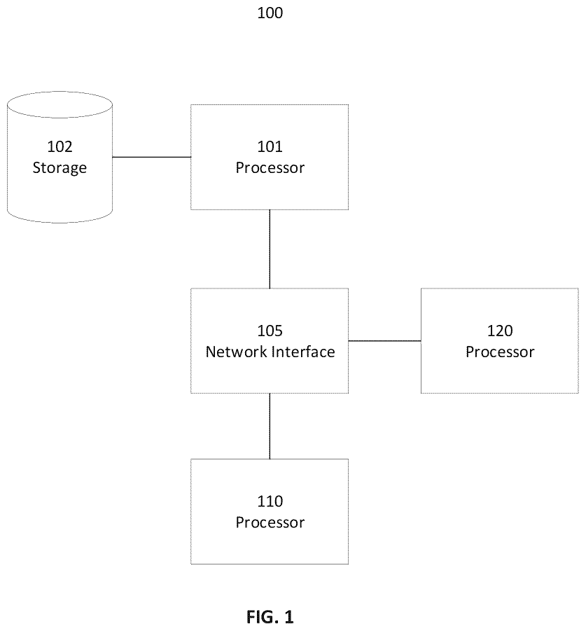

Reference is now made to FIG. 1, showing an exemplary system 100 for generating synthetic training data, according to some embodiments. In such embodiments, processing unit 101 is connected to at least one non-volatile digital storage 102, optionally for the purpose of accessing simulation data. Optionally, the processing unit 101 stores new simulation data on at least one non-volatile digital storage 102. Some examples of a non-volatile digital storage include, but are not limited to, a hard disk drive, a network connected storage and a storage network. Optionally, the processing unit 101 is connected to at least one non-volatile digital storage via at least one digital communication network interface 105. Optionally, at least one digital communication network interface 105 is connected to a local area network (LAN), for example an Ethernet network or a Wi-Fi network. Optionally, at least one digital communication network interface 105 is connected to a wide area network (WAN), for example the Internet or a cellular network.

Optionally, the processing unit 101 is connected to another processing unit 110, optionally via at least one digital communication network interface 105. Optionally the processing unit 101 receives the simulation data from the other processing unit 110.

Optionally, the processing unit 101 is connected to an additional processing unit 120, optionally via at least one digital communication network interface 105. Optionally, the additional processing unit 120 trains at least one perception model using new simulation data generated by the processing unit 101. Optionally, the at least one perception model comprises a computer-vision based perception model. Optionally, the at least one perception model comprises a perception model based on another sensation, for example audio or a tactile sensation, for example temperature.

Optionally, the processing unit 101 comprises the other processing unit 110. Optionally, the processing unit 101 comprises the additional processing unit 120.

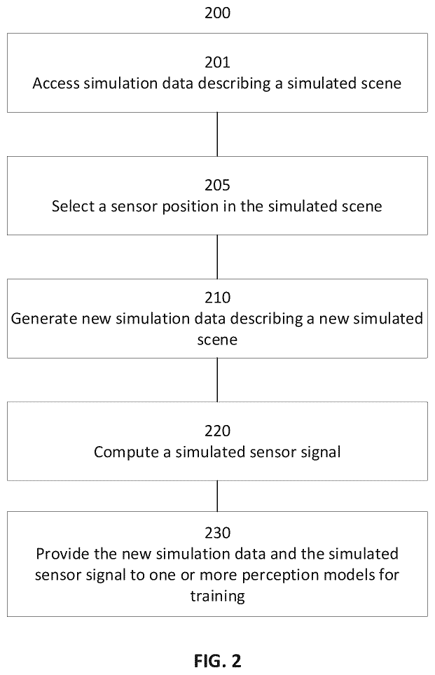

Reference is now made also to FIG. 2, showing a flowchart schematically representing an optional flow of operations 200 for generating synthetic training data, according to some embodiments. Optionally, in 201 the processing unit 101 accesses simulation data describing a simulated scene. Optionally, the processing unit 101 retrieves the simulation data from at least one non-volatile digital storage 102. Optionally, the processing unit 101 receives the simulation data from the processing unit 110. The simulated scene may be chosen according to one or more attributes of the simulated scene. Some examples of a scene attribute are a type of scene, for example an urban scene, a suburban scene, a rural scene, a mountainous scene, a wooded scene, a scene with a body of water, an indoors scene etc. Optionally the scene simulates a known geographical location, for example a known city for example New York or New Deli. Another example of an attribute is weather conditions—for example a rainy scene, a sunny scene, a cloudy scene. Another example of an attribute is a time of day. A time of day may effect light in the simulated scene. Optionally, in 205 the processing unit 101 selects a sensor position in the simulated scene. Optionally, the sensor position is selected at random. Using a random sensor position increases a likelihood of generating diverse synthetic data to fulfil the target coverage function. Optionally, the processing unit 101 computes the sensor position according to one or more position acceptance tests, for example a test defining a range of heights of the sensor from a ground level of the simulated scene. Optionally, the processing unit 101 applies the one or more position acceptance tests to a randomly selected sensor position. Optionally, the sensor position does not adhere to a physical constraint of the simulated scene, for example when producing training data to train a computer-vision based perception model for an autonomous driving system the sensor position may be a position that is not representative of a sensor mounted on a vehicle traversing the simulated scene.

Optionally, the simulation data comprises a plurality of frames, where each frame comprises full ground truth of the simulation scene such as 2D/3D bounding boxes, semantic segmentation, instance segmentation, free space segmentation, polygon annotation and such.

In 210, the processing unit optionally generates new simulation data describing a new simulated scene. Optionally, to generate the new simulated scene the processing unit adds to (inserts into) the simulation data describing the simulated scene one or more objects. Optionally, the one or more objects are selected from a set of simulation objects. Optionally, the set of simulation objects consists of a large variety of objects. Optionally, the set of simulation objects comprises objects that are not typical in the field for which the synthetic data is generated. For example, for synthetic data for training a driver system, the set of simulation objects may include one or more furniture objects, such as a sofa (which typically is not an object found on a road). Optionally, the one or more objects are selected from the set of simulation objects at random. Optionally, the set of objects includes more than one object of a given type. For example, the set of simulation objects may have more than one traffic sign. Other examples of objects include, but are not limited to: a car, a truck, a motorized vehicle, a train, a boat, an air-born vehicle, a waterborne vessel, a motorized scooter, a scooter, a bicycle, and animal, vegetation such as a tree or a shrub, and a person. A person may be of any gender or age. A person may be mounted on another object, for example a bicycle, a wheelchair, or a horse. A person may be holding an object, for example a walking canc. A person may be standing. Optionally a person is sitting or pronc. Other examples of an object include: a sidewalk, a curb, a traffic sign, a billboard, an obstacle, a mountain wall, a ditch, a post such as a lamp post, a rail, a fence, a building, a tree, a wall, and a road mark. An animal may be a bird. An animal may be a mammal. An animal may be a fish. Optionally, an object is a household object. Some examples of a household object are a piece of furniture, for example a couch or a table, and an electrical appliance, for example a refrigerator or a television.

Optionally, the set of simulation objects has a subset of objects of interest. For example, when generating synthetic data for use with an autonomous driving system, the subset of objects of interest may include a plurality of traffic signs.

Optionally, each of the set of simulation objects has a front view. Optionally, each of the simulation objects has one or more rotation angel ranges. Optionally, each rotation angle range is in relation to a plane relative to a reference plane in the simulated scene, for example a ground level of the simulated scene. Each of the rotation angle ranges is indicative of a range of rotation, inclination and/or pitch angles of the respective object with relation to an initial orientation.

Optionally, an object is inserted into the new simulated scene such that the object's front view is oriented towards the sensor position. Optionally, the object is inserted into the new simulated scene such that the object's front view is rotated relative to the sensor position on a selected plane relative to the reference plane at a rotation angle. Optionally, the rotation angle is in a respective rotation angle range of the object associated with the selected plane. Optionally, the rotation angle is selected at random, optionally from the respective rotation angle range. Thus, instead of facing the sensor position head on, the object may be rotated to the left or right, tilted at an inclination or reverse inclination, or rotated at any other pitch angle that is defined by one of the ranges of rotation angles of the object. Facing a simulated object towards the sensor position enables providing a perception model with a signal comprising some objects such as traffic signs/lights which have a part such as text which can be read only when viewed from a limited amount of directions and cannot be read from a back view of the simulation object or from a very narrow angle relative to the front view of the simulation object.

On the other hand, for some simulation objects such as pedestrians and vehicles, for some applications the object is still interesting even if it is fully rotated. In addition, for some other applications such as planning and control, the application should react differently to an object depending on a tendency of a simulated object to cross a given path. Thus, when creating simulation data, there may be a need to concentrate on objects that are oriented towards the sensor, or alternatively concentrate on simulation objects that are not oriented towards the sensor. Rotating an object within the rotation angle range, increases diversity of the generated synthetic training data while increasing a likelihood of the generated synthetic training data to meet the target coverage function (some objects have a large range of rotation, some have a narrow range of rotation).

Optionally, the processing unit 101 inserts an object of the one or more objects into the new simulation data according to one or more physical constraints that are applied to the object and the simulated scene. For example, a light post may be inserted only starting from the ground, not floating in the air. Similarly, a couch may be placed on a solid surface in the simulated scene. In another example, two of more solid objects may not be inserted at the same position. Inserting the one or more objects according to the one or more physical constraints preserves the structure of a realistic scene in the new simulated scene, increasing usability of the simulation data and increasing accuracy of the model trained using the synthetic data generated using the new simulated scene.

Optionally, the processing unit adds each of the one or more objects in an object position in the simulated scene. Optionally, the object position is selected at random. Optionally, the object position is generated relative to the sensor position according to the target coverage function. Optionally, the object position is computed according to an identified functionality of the system using the perception model and additionally or alternatively according to one or more parameters of the sensor. For example, when the model is used in a driving system to recognize traffic signs, it may be that a speed sign should be detected and classified from a maximum distance of 30 meters from the sensor when the sensor is a camera with a 1 mega-pixel resolution and where the sign is at an angle of no more than 45 degrees with a lane in which the sensor is moving. A speed sign that does not meet these conditions may be considered as not relevant to the vehicle in which the system operates.

A possible method of adding the one or more objects to the simulated data comprises distributing the one or more objects in one or more concentric circles around the sensor position. This method facilitates capturing in one or more simulated sensor signals a variety of simulated objects with a variety of backgrounds and orientations towards the simulated sensor.

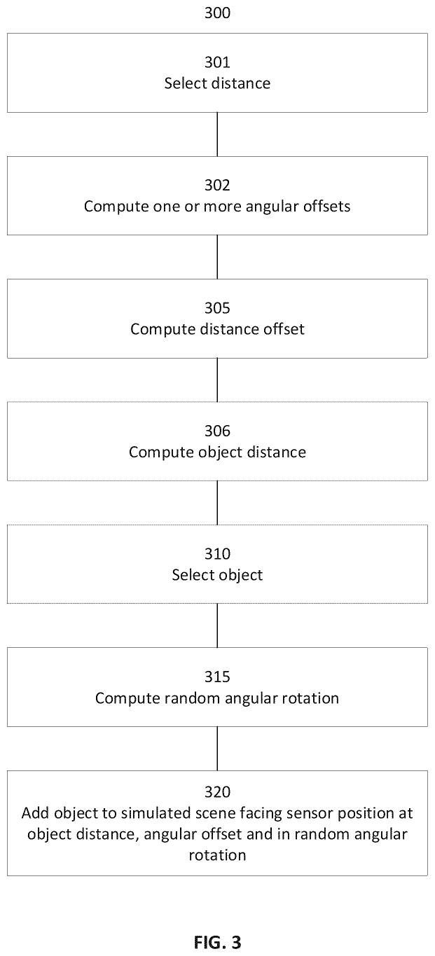

Reference is now made also to FIG. 3, showing a flowchart schematically representing an optional flow of operations 300 for adding objects to a simulated scene, according to some embodiments.

In 301 the processing unit 101 optionally selects a base distance from the sensor position. Optionally, the base distance is selected from one or more base distances.

Optionally, the processing unit 101 computes an angular density of objects around the sensor position at the base distance, optionally according to the target coverage function and the set of simulation objects. As used herewithin, the angular density is indicative of a distribution of objects around the sensor position at the base distance. For example, when simulation objects are large in size, fewer objects can fit around the sensor position at the base distance than when the simulation objects are small in size. Similarly, when the base distance is close to the sensor position fewer objects can fit around the sensor position than at a base distance that is further away.

Optionally, in 302, the processing unit 101 selects or computes one or more positions in the simulated scene according to the angular density, each at a distance from the sensor position that is equal to the base distance. Thus, the positions are optionally selected in an outline of a circle around the sensor position, such that each position has an angular offset with respect to an identified orientation of the sensor. Optionally, the processing unit 101 selects the one or more positions according to the angular density at random.

In 305, the processing unit 101 optionally computes a random distance offset from the base distance. Optionally, the random distance offset is in an identified range of distance offsets, for example between −1 meter and 1 meter from the base distance. In 306 the processing unit 101 optionally computes an object distance from the sensor position by adding the random distance offset to the base distance. Thus, objects are placed in an outline of a circle around the sensor position but not at exactly equal distances. Optionally, the processing unit 101 repeats 305 and 306 for each of the one or more positions.

In 310, for a position in the one or more positions, the processing unit 101 optionally selects an object from the set of simulation objects. Optionally, the processing unit 101 first selects one or more objects, one for each of the plurality of positions, and then executes 305 and 306 for each of the objects.

For each of the one or more positions, the angular offset of the position and the object distance define an object position.

In 315, the processing unit 101 optionally computes a random angular rotation for the object selected in 310, according to the object's one or more rotation angel ranges.

In 320, the processing unit 101 optionally adds the object to the simulation data in the object position in the simulated scene, such that the object is added at a distance from the sensor position that is equal to the object distance and at the angular offset with respect to the identified orientation of the sensor. Optionally, the processing unit 101 adds the object to the simulation data in a new object position in the simulated scene instead of in the object position, such that the object is added at a distance from the sensor position that is equal to the base distance and at the angular offset with respect to the identified orientation of the sensor. Optionally, the processing unit adds the object to the simulation data. Optionally, processing unit 101 adds the object at an orientation having the random angular rotation with respect to the sensor position and the object's front view.

Optionally, the processing unit 101 repeats 310, 315 and 320 for each of the one or more positions.

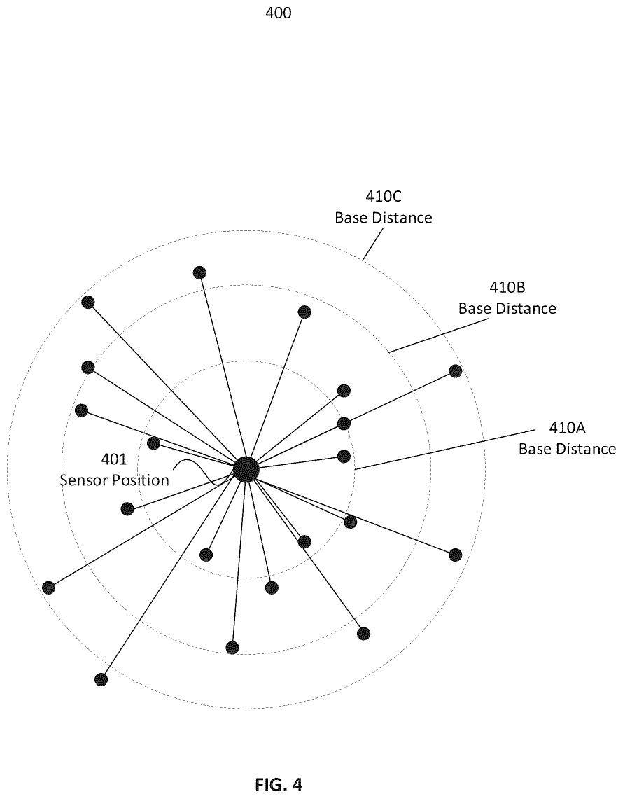

Reference is made now also to FIG. 4, showing a block diagram schematically showing an exemplary distribution 400 of objects around a sensor position, according to some embodiments. In such embodiments, one or more objects are added to a simulated scene in according to one or more base distances from a sensor position 401. Optionally, the one or more base distances comprise base distance 410A, base distance 410B and base distance 410C, collectively referenced as one or more base distances 410. Each object is optionally added at an offset from one of the one or more base distances 410, where the distribution of the objects around the sensor position is optionally according to an angular density which is optionally computed according to the target coverage function.

Optionally, the one or more base distances 410 comprises at least one close distance, for example base distance 410A, and at least one background distance, for example base distance 410B and base distance 410C, where each of the at least one close distance 410A is less than the at least one background distance 410B and 410C.

Reference is now made again to FIG. 3.

Optionally, in 310, for the one or more close distances 410A, the respective one or more objects are selected from the subset of objects of interest. Optionally, for the one or more background distances 410B and 410C the respective one or more objects are selected from the set of simulation objects that are not members of the subset of objects of interest. In such a new simulated scene, objects of interest are closer to the sensor than other objects, capturing the objects of interest against a variety of backgrounds created by the other objects.

Optionally, each of the set of simulation objects has a plurality of object classifications. Optionally, for an object of the set of simulation objects, each of the plurality of object classifications thereof is indicative of a plurality of values of a plurality of object attributes of the simulation object. Optionally, the processing unit 101 selects the one or more objects according to the target coverage function. Optionally, the one or more objects have one or more target object classifications that are identified by applying the target coverage function to the simulation data. For example, the one or more target object classifications may include an identified color. Other examples of a target object classification include an identified size or an identified size range, for example having a width that exceeds an identified threshold width, and an identified shape, for example round street signs.

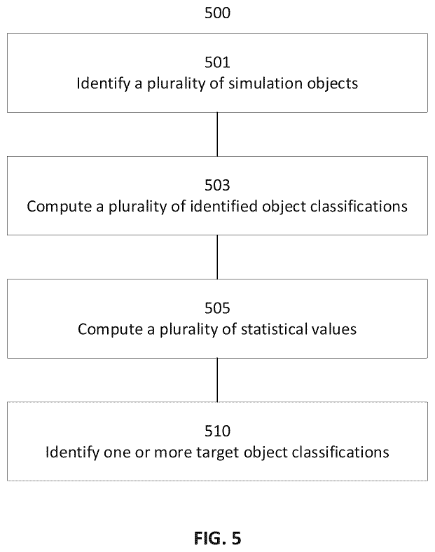

Reference is now made also to FIG. 5, showing a flowchart schematically representing an optional flow of operations 500 for computing a target object classification, according to some embodiments. Optionally, in 501 the processing unit 101 identifies a plurality of simulation objects in the simulation data. Optionally, in 503 the processing unit 101 computes a plurality of identified object classifications of the plurality of simulation objects. In 505, the processing unit 101 optionally computes a plurality of statistical values according to the plurality of identified object classifications and in 510 the processing unit 101 optionally identifies the one or more target object classifications according to the plurality of statistical values.

Optionally, the processing unit 101 compares the plurality of identified object classifications to a list of target object classifications. Optionally, the processing unit 101 compares the plurality of statistical values to a plurality of target statistical values. For example, in 505 the processing unit 101 may compute an amount of the plurality of simulation objects having a first identified object classification, for example an identified color. Further in this example, in 510 the processing unit 101 may identify that the amount of the plurality of simulation objects having the first identified object classification is less than an identified threshold amount according to the target coverage function, thus identifying the first identified object classification as a target object classification.

Reference is now made again to FIG. 2. Optionally, the processing unit 101 divides the simulated scene into a plurality of areas, for example quadrants, and positions each of the at least one objects in one of the plurality of areas, optionally according to the target coverage function.

Optionally, the processing unit 101 generates the new simulation data using method 200 without using the simulation data, generating one or more new simulated scenes by selecting the one or more objects according to the target coverage function and inserting the one or more objects in a simulated scene distributed around a sensor position.

In 220, the processing unit 101 optionally computes at least one simulated sensor signal. Optionally, the at least one simulated sensor signal simulate at least one signal captured by a simulated sensor located in the sensor position in the new simulated scene. Capturing a sensor signal from the sensor position when the one or more objects are oriented towards the sensor position increases a likelihood of capturing one or more front views of the one or more objects. Optionally, the at least one simulated sensor signal simulate at least one signal captured when the sensor moves around its own axis in the sensor position, i.e. the sensor pivots, optionally in a 360-degree circle. Moving the sensor around in 360 degrees on the sensor position captures a 360-degree scan of the scene from the sensor position and captures the one or more objects at a variety of angles of diverse backgrounds, increasing diversity of the generated synthetic data to fulfil the target coverage function and thus increases accuracy of a model trained using the generated synthetic data.

Optionally, in 230 the processing unit 101 provides the new simulation data and the at least one simulated sensor signal to one or more perception models as synthetic training data for training the one or more perceptions models to detect and additionally or alternatively classify one or more objects in one or more sensor signals. Optionally, the one or more perception models comprise a computer-vision based perception model. Optionally, the processing unit 101 provides the new simulation data and the at least one simulated sensor signal to the additional processing unit 120 for training the one or more perception models.

Method 200 may be repeated for more than one simulated scene. Method 200 may be repeated for the same simulated scene, selecting each time a new sensor position. Method 200 may be repeated for the same simulated scene and the same sensor position, each time inserting different objects and different object positions and additionally or alternatively changing orientation of the sensor in the sensor position in relation to the simulated scene.

In some embodiments described herewithin, a perception model trained by system 100 is used in a perception system.

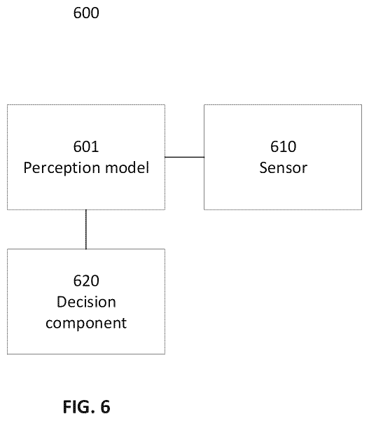

Reference is now made also to FIG. 6, showing a block diagram schematically showing an exemplary perception system 600, according to some embodiments. In such embodiments, one or more perception models 601 are connected to one or more sensors 610 and to one or more decision components. Optionally, the perception system comprises one or more hardware processors. Optionally, the one or more hardware processors execute the one or more perception models. Optionally, the one or more perception models comprise model circuitry. Optionally, the one or more hardware processors execute the one or more decision components. Optionally, the one or more decision components comprise decision circuitry.

Optionally, the one or more perception models are trained using method 200, optionally executed by system 100. For example, when system 600 is an autonomous driving system, the one or more perception models may comprise at least one computer-vision based perception model trained using method 200.

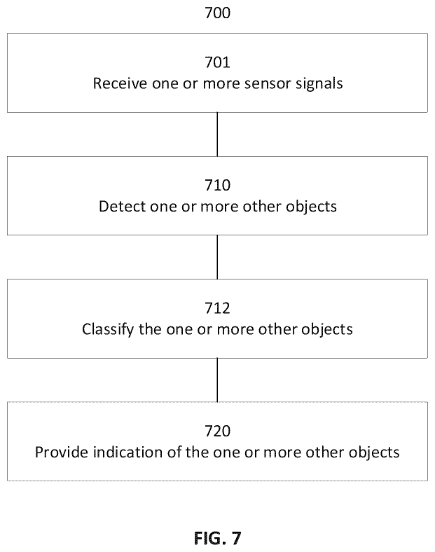

In some embodiments, system 600 implements the following optional method. Reference is now made also to FIG. 7, showing a flowchart schematically representing an optional flow of operations 700 for a perception system, according to some embodiments. In such embodiments, in 701 the one or more perception models 601 receive one or more other sensor signals, optionally from one or more sensor 610. For example, when one or more sensor 610 comprises a digital camera, the one or more sensor signals may comprise a sequence of digital images. When system 600 is an autonomous driving system, the one or more sensors 610 may be mounted on a vehicle comprising the autonomous driving system. Optionally, the one or more signals are captured while the vehicle traverses a physical environment.

Optionally, in 710, the one or more perception models 601 detect one or more other objects in the one or more other sensor signals. For example, when the system 600 is an autonomous driving system, the one or more perception models may detect in the one or more other signals one or more vehicles and additionally or alternatively one or more road signs.

Optionally, in 712, the one or more perception models 601 classify the one or more other objects. For example, the one or more perception models 601 may classify one of the one or more other objects as a speed limit sign limiting driving speed to an identified speed limit. Optionally, the one or more perception models 601 receive input additional to the one or more signals. Optionally, the input comprises information indicative of the one or more other simulation objects. Optionally, the one or more perception models 601 classify the one or more other objects instead of detecting the one or more other objects in the one or more other signals, for example when the one or more other objects are detected by another model that provides the one or more prediction models 601 with the information indicative of the one or more other simulation objects.

Optionally, in 720, the one or more perception models 601 provides an indication of the one or more other objects to the one or more decision components 620. Optionally, the indication comprises one or more classifications of the one or more other objects. For example, in an autonomous driving system, the indication may comprise a speed limit, which the decision component may compare to a velocity of the vehicle. In another example in an autonomous driving system, the indication may comprises a classification of a detected object as another vehicle and a distance from the vehicle in which the autonomous driving system is installed.

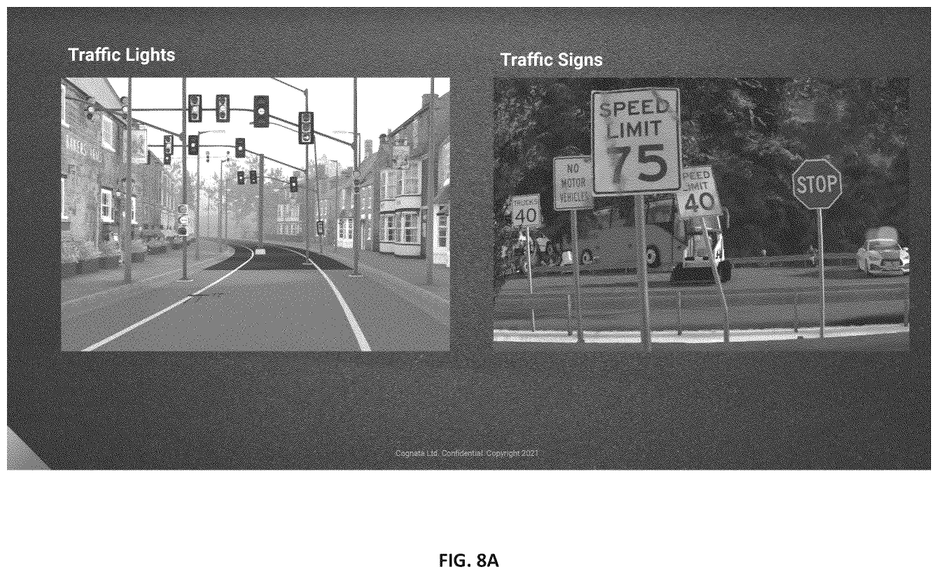

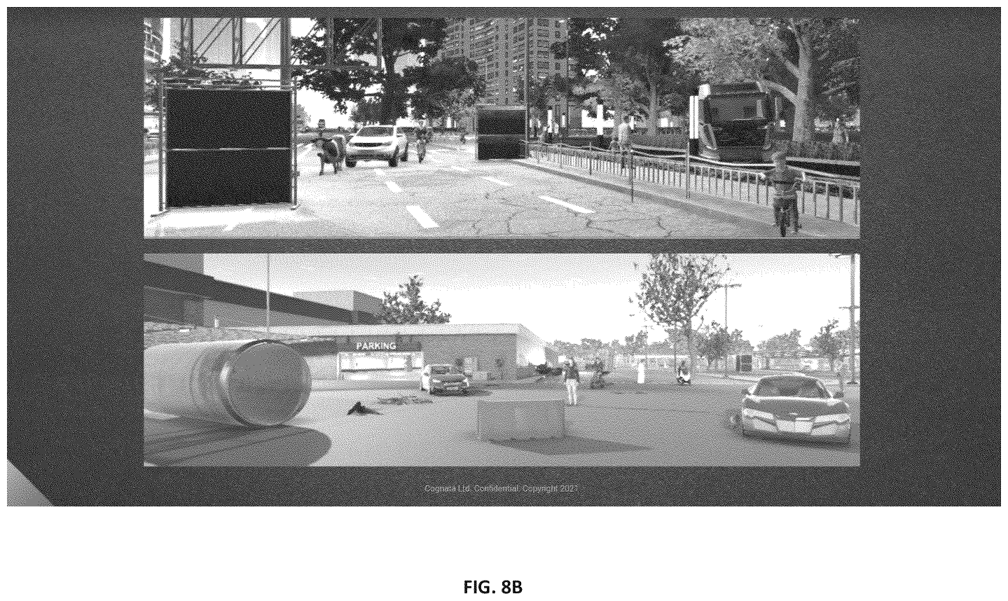

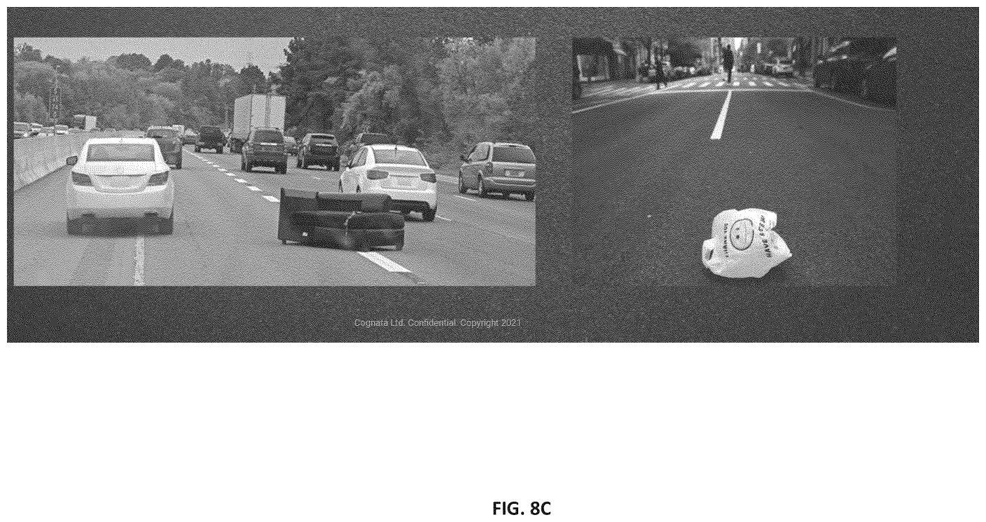

Reference is now made also to FIGS. 8A, 8B and 8C, showing exemplary digital images captured from one or more exemplary new simulation environments having one or more added objects, according to some embodiments.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant objects, sensors, digital signals and machine learning models for machine perception will be developed and the scope of the terms object, sensor, digital signal and “machine learning model for machine perception” are intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A system for training a computer-vision based perception model, comprising at least one hardware processor adapted for:
generating synthetic training data by:
generating new simulation data describing a new simulated scene by inserting into simulation data describing a simulated scene at least one object, selected from a set of simulation objects wherein each object of the set of simulation objects has one or more rotation angle ranges, each rotation angle range being in relation to a plane relative to a reference plane in the simulated scene, the at least one object inserted in an object position in the simulated scene generated relative to a sensor position in the simulated scene according to a target coverage function, each object of the at least one object having a front view, the object inserted into the simulated scene such that the object's front view is oriented towards the sensor position such that for at least one rotation angle range of the one or more rotation angle ranges, the at least one object's front view is rotated relative to the sensor position on the respective plane of the rotation angle range at an angle selected from the at least one rotation angle range; and
computing at least one simulated sensor signal, simulating at least one signal captured by a simulated sensor located in the sensor position in the new simulated scene; and
providing the new simulation data and the at least one simulated sensor signal as synthetic training data to at least one computer-vision based perception model for training the model to detect and additionally or alternatively classify one or more objects in one or more sensor signals.

2. (canceled)

3. The system of claim 12, wherein the angle is selected at random from the at least one rotation angle range.

4. The system of claim 1, wherein the sensor position in the simulated scene is selected at random.

5. The system of claim 1 wherein the sensor position in the simulated scene is computed according to at least one position acceptance test.

6. The system of claim 1, wherein the object position in the simulated scene is selected at random.

7. The system of claim 1, wherein inserting the at least one object into the simulation data comprises:
for each of one or more base distances:
computing an angular density according to the target coverage function and the set of simulation objects;
randomly selecting one or more positions in the simulated scene according to the angular density, each at the respective base distance from the sensor position and having an angular offset with respect to an identified orientation of the sensor; and
for each of the one or more positions:
selecting a simulation object from the set of simulation objects; and
adding the simulation object to the simulation data at an object position in the simulated scene that is at the base distance from the sensor position and has the angular offset with respect to the identified orientation of the sensor.

8. The system of claim 7, further comprising for each of the one or more positions:
computing a random offset from the base distance, such that the random offset is in an identified range of distance offsets;
computing an object distance by adding the random offset to the base distance; and
adding the simulation object to the simulation data at another object position in the simulated scene that is at the object distance from the sensor position and has the angular offset with respect to the identified orientation of the sensor, instead of at the object positon that is at the base distance from the sensor position.

9. The system of claim 7, wherein the set of simulation objects comprises a subset of objects of interest;
wherein the one or more base distances comprise at least one close distance and at least one background distance, where each of the at least one close distance is less than any of the at least one background distance; and
wherein for the at least one close distance, the respective one or more objects selected therefor are selected from the subset of objects of interest; and
wherein for the at least one background distance the respective one or more objects selected therefor are not members of the subset of objects of interest.

10. The system of claim 1, wherein adding the at least one object to the simulated scene is according to one or more physical constraints applied to the at least one object and the simulated scene.

11. The system of claim 1, wherein the set of simulation objects comprises at least one of: a car, a truck, a motorized vehicle, a train, a boat, an air-born vehicle, a waterborne vessel, a motorized scooter, a scooter, a bicycle, a road sign, a household object, a bench, a post, a person, an animal, a vegetation, a sidewalk, a curb, a traffic sign, a billboard, an obstacle, a mountain wall, a ditch, a rail, a fence, a building, a wall, and a road mark.

12. The system of claim 1, wherein the at least one object is selected at random from the set of simulation objects.

13. The system of claim 1, wherein each of the set of simulation objects has a plurality of object classifications;
wherein the at least one object has at least one target object classification, identified by applying the target coverage function to the simulation data.

14. The system of claim 13, wherein the at least one target object classification comprises at least one of: an identified color, an identified size, and an identified shape.

15. The system of claim 13, wherein applying the target coverage function to the simulation data comprises:
identifying a plurality of simulation objects in the simulation data;
computing a plurality of identified object classifications of the plurality of simulation objects;
computing a plurality of statistical values according to the plurality of identified object classifications; and
identifying the at least one target object classification according to the plurality of statistical values.

16. The system of claim 1, wherein computing the at least one simulated sensor signal comprises the simulated sensor pivoting around an axis in the sensor position.

17. A method for training a computer-vision based perception model, comprising:
generating synthetic training data by:
generating new simulation data describing a new simulated scene by inserting into simulation data describing a simulated scene at least one object, selected from a set of simulation objects wherein each object of the set of simulation objects has one or more rotation angle ranges, each rotation angle range being in relation to a plane relative to a reference plane in the simulated scene, the at least one object inserted in an object position in the simulated scene generated relative to a sensor position in the simulated scene according to a target coverage function, each object of the at least one object having a front view, the object inserted into the simulated scene such that the object's front view is oriented towards the sensor position such that for at least one rotation angle range of the one or more rotation angle ranges, the at least one object's front view is rotated relative to the sensor position on the respective plane of the rotation angle range at an angle selected from the at least one rotation angle range; and
computing at least one simulated sensor signal, simulating at least one signal captured by a simulated sensor located in the sensor position in the new simulated scene; and
providing the new simulation data and the at least one simulated sensor signal as synthetic training data to at least one computer-vision based perception model for training the model to detect and additionally or alternatively classify one or more objects in one or more sensor signals.

18. (canceled)

19. An autonomous driving system, comprising:
at least one sensor;
at least one decision component; and
at least one computer-vision based perception model connected to the at least one sensor and the at least one decision component, the at least one perception model trained to detect and additionally or alternatively classify one or more objects in one or more sensor signals, the training comprising:
generating synthetic training data by:
generating new simulation data describing a new simulated scene by inserting into simulation data describing a simulated scene at least one object, selected from a set of simulation objects wherein each object of the set of simulation objects has one or more rotation angle ranges, each rotation angle range being in relation to a plane relative to a reference plane in the simulated scene, the at least one object inserted in an object position in the simulated scene generated relative to a sensor position in the simulated scene according to a target coverage function, each object of the at least one object having a front view, the object inserted into the simulated scene such that the object's front view is oriented towards the sensor position such that for at least one rotation angle range of the one or more rotation angle ranges, the at least one object's front view is rotated relative to the sensor position on the respective plane of the rotation angle range at an angle selected from the at least one rotation angle range; and
computing at least one simulated sensor signal, simulating at least one signal captured by a simulated sensor located in the sensor position in the new simulated scene; and
providing the new simulation data and the at least one simulated sensor signal as synthetic training data to the at least one computer-vision based perception model for training the model to detect and additionally or alternatively classify the one or more other objects in the one or more other sensor signals;
wherein the at least one perception model is configured for:
receiving by the at least one computer-vision based perception model one or more other sensor signals from the at least one sensor;
detecting one or more other objects in the one or more other sensor signals; and
providing an indication of the one or more other objects to the at least one decision component.

20. The autonomous driving system of claim 19, the at least one perception model is further configured for classifying the one or more other objects.

21. The autonomous driving system of claim 20, wherein classifying the one or more other objects is alternatively to detecting the one or more other objects in the one or more other sensor signals.

22. (canceled)
